(19) United States
(12) Patent Application Publication
(10) Pub. No.: US 2018/0251266 A1
(43) Pub. Date: Sep. 6, 2018

(54) CONTAINER FOR CARDS AND METHOD OF PRINTING A GENERALLY CONTINUOUS IMAGE ON A MULTI-SIDED CONTAINER

(71) Applicant: Pirate Lab LLC, Evanston, IL (US)

(72) Inventors: Alexis Schilf, Carol Stream, IL (US); Russell Potterfield, Winnetka, IL (US); Christopher Wilburn, Chicago, IL (US); Charles McArthur, Chicago, IL (US); Michael Miller, Park Ridge, IL (US); Wang Ru Xian, Shenzhen (CN); Zhou Xiao Jun, Shenzhen (CN)

(21) Appl. No.: 15/450,381

(22) Filed: Mar. 6, 2017

(51) Int. Cl. B65D 25/20; B65D 43/16; B65D 43/02; A63F 1/06; B41J 3/407

(52) U.S. Cl. CPC B65D 25/205; B65D 43/16; B41J 3/4073; A63F 1/062; B65D 43/0202

(57) ABSTRACT

A container for holding cards includes a base having a bottom wall and a first plurality of side walls extending from the bottom wall, and a lid movable relative to the base between an open position and a closed position. The lid includes a top wall and a second plurality of side walls extending from the top wall. Each of the second plurality of side walls is generally aligned with a corresponding one of the first plurality of side walls when the lid is in the closed position. The container further includes an internal storage volume at least partially defined by the bottom wall, the top wall, and the first and second pluralities of side walls, and a generally continuous image printed on the first and second pluralities of side walls such that portions of the image are substantially aligned at interfaces between adjacent side walls.

### BACKGROUND

The present disclosure relates to containers for storing cards and more particularly to such containers having textures and printed images.

### SUMMARY

In one aspect, a container for holding cards includes a base having a bottom wall and a first plurality of side walls extending from the bottom wall, and a lid movable relative to the base between an open position and a closed position. The lid includes a top wall and a second plurality of side walls extending from the top wall. Each of the second plurality of side walls is generally aligned with a corresponding one of the first plurality of side walls when the lid is in the closed position. The container further includes an internal storage volume at least partially defined by the bottom wall, the top wall, and the first and second pluralities of side walls, and a generally continuous image printed on the first and second pluralities of side walls such that portions of the image are substantially aligned at interfaces between adjacent side walls.

In another aspect, a method of printing a generally continuous image on a multi-sided container includes positioning the container in a printer using a first jig, printing a first portion of the image on a first side of the container with the printer, rotating the container relative to the first jig, and printing a second portion of the image on a second side of the container with the printer.

In another aspect, a method of printing a generally continuous image on a multi-sided container includes positioning the container in a printer using a first jig, printing a first portion of the image on a first side of the container with the printer, rotating the container relative to the first jig, and printing a second portion of the image on a second side of the container with the printer. The method further includes positioning the container in the printer using a second jig, printing a third portion of the image on a third side of the container with the printer, rotating the container relative to the second jig, and printing a fourth portion of the image on a fourth side of the container with the printer. The method further includes positioning the container in the printer using a third jig, and printing a fifth portion of the image on a fifth side of the container with the printer.

Other aspects of the disclosure will become apparent by consideration of the detailed description and accompanying drawings.

### BRIEF DESCRIPTION OF THE DRAWINGS

FIG. 1 is a perspective view of a container according to one embodiment of the disclosure.

FIG. 2 is a perspective view of the container of FIG. 1, with a lid of the container in an open position.

FIG. 3 is a perspective view of a container according to another embodiment of the disclosure.

FIG. 4 is a perspective view of the container of FIG. 3, with a lid of the container in an open position.

FIG. 5 is a perspective view of a container according to another embodiment of the disclosure.

FIG. 6 is a perspective view of the container of FIG. 5, with a lid of the container in an open position.

FIG. 7 is a perspective view of a container according to another embodiment of the disclosure.

FIG. 8 is a perspective view of the container of FIG. 7, with a lid of the container in an open position.

FIG. 9 is a perspective view of a first jig that can facilitate printing a portion of an image on first and second sides of a container.

FIG. 10 is a perspective view of a second jig that can facilitate printing a portion of the image on third and fourth sides of the container.

FIG. 11 is a perspective view of a third jig that can facilitate printing a portion of the image on a fifth side of the container.

FIG. 12 is a perspective view of the first jig of FIG. 9 positioned in a printer.

FIG. 13 is a perspective view of the second jig of FIG. 10 positioned in the printer.

FIG. 14 is a perspective view of the third jig of FIG. 11 positioned in the printer.

FIG. 15 is a flow chart illustrating a method of printing a generally continuous image on a multi-sided container according to one embodiment of the disclosure.

FIG. 16 is a perspective view of a container including a generally continuous image printed thereon.

Before any embodiments of the disclosure are explained in detail, it is to be understood that the disclosure is not limited in its application to the details of construction and the arrangement of components set forth in the following description or illustrated in the accompanying drawings. The disclosure is capable of supporting other embodiments and of being practiced or of being carried out in various ways.

### DETAILED DESCRIPTION

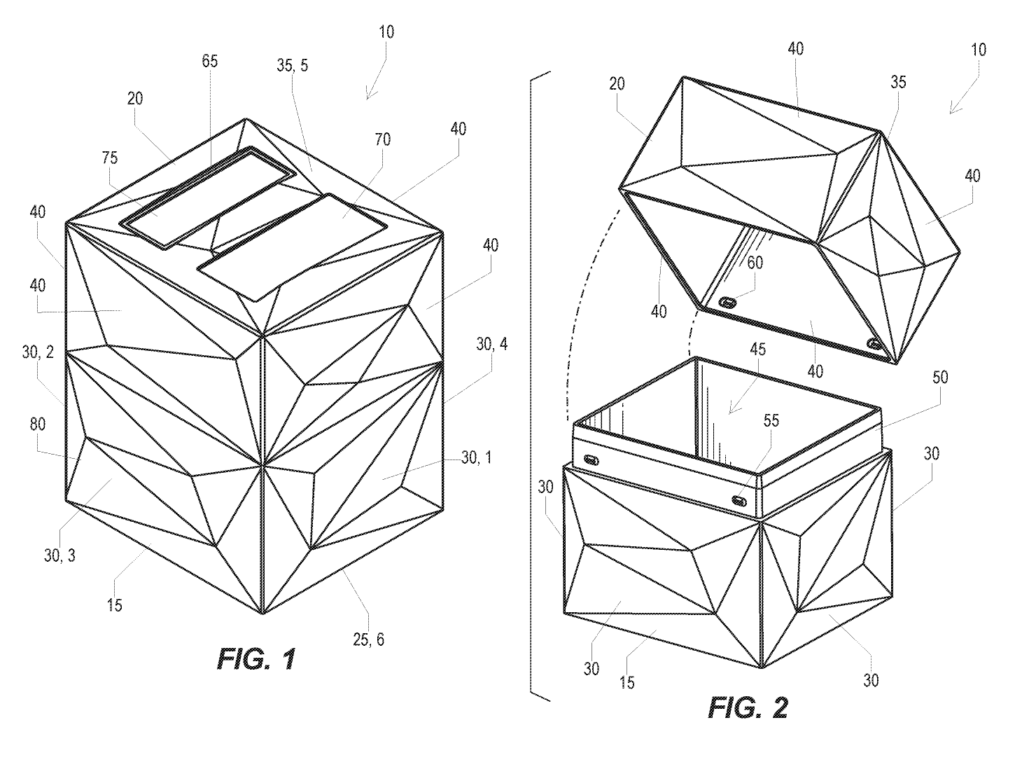

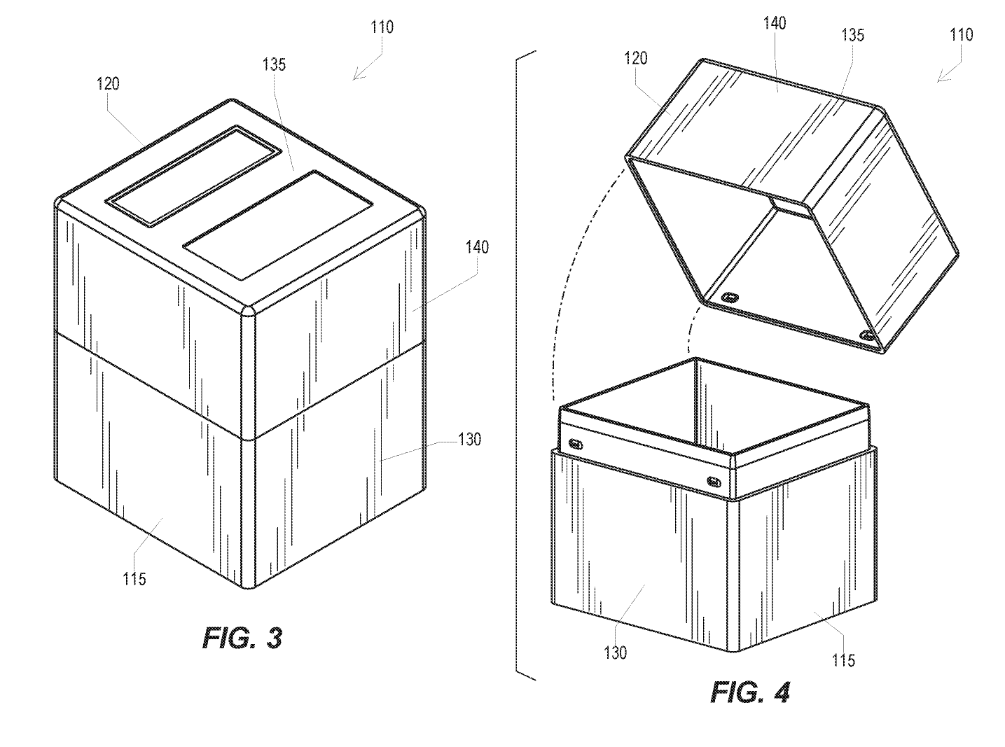

FIGS. 1 and 2 illustrate a container or box 10 for holding cards according to one embodiment. The container 10 includes a base 15 and a lid 20 removably coupled to the base 15. As such, the lid 20 is movable relative to the base 15 between a closed position (FIG. 1) and an open position (FIG. 2). In the illustrated embodiment, the lid 20 is completely separated from the base 15 in the open position; however, in other embodiments, the lid 20 may remain attached to the base 15 via a hinge, strap, or other suitable coupling. In the illustrated embodiment, the base 15 and the lid 20 can be made of plastic (e.g., ABS plastic, PP plastic, PC plastic, etc.) via an injection-molding process. In other embodiments, the base 15 and the lid 20 can be made of metal (e.g., aluminum) via various processes including, but not limited to, a deep drawing process. The base 15 and the lid 20 can be made of any other material offering sufficient rigidity to protect contents stored within the container 10.

The base 15 has a bottom wall 25 and a plurality of side walls 30 extending from the bottom wall 25. The lid 20 has a top wall 35 and a plurality of side walls 40 extending from the top wall 35. The lid 20 and the base 15 cooperate to define an internal storage volume 45 sized and shaped to store one or more decks of cards (such as trading cards, playing cards, sports cards, and the like). In some embodiments, the container 10 can hold between about 70 cards and about 120 cards. In other embodiments, the container 10 can hold a greater or lesser number of cards.

With continued reference to FIGS. 1 and 2, the illustrated base 15 and lid 20 each include four side walls 30, 40 such that the container 10 is generally shaped as a rectangular prism. As such, with reference to the orientation illustrated in FIG. 1, the container 10 includes a front side 1, a back side 2, a left side 3, a right side 4, a top side 5, and a bottom side 6. In some embodiments, the container 10 may be shaped as a square prism. In other embodiments, the container 10 may be shaped as a cube. In other embodiments, the base 15 and lid 20 may include other numbers of side walls that define a variety of other shapes.

Each of the illustrated side walls 30 includes a recessed portion 50 having a reduced cross-sectional area or stepped-in region, such that a step or shoulder is defined between the stepped-in region and the rest of the side walls 30. (FIG. 2). When the lid 20 is in the closed position, the lid side walls 40 fit over the recessed portions 50 and abut the shoulder, and each of the base side walls 30 is generally aligned with a corresponding one of the lid side walls 40. (FIG. 1). In the illustrated embodiment, the base 15 further includes a plurality of retainers, which are rounded projections or detents 55 disposed on one or more of the recessed portions 50. The detents 55 are engageable with corresponding recesses 60 on the interior of the lid 20 to retain the lid 20 in the closed position. In the illustrated embodiment, the detents 55 have an oval shape; however, the detents 55 may be circular or have any other shape suitable for sliding into the recesses 60 when the lid 20 is moved to the closed position. In other embodiments, any other number and arrangement of detents 55 and recesses 60 may be provided. In some embodiments, the base 15 may include the recesses 60, and the lid 20 may include the detents 55. The term “detent” is used in this description to refer to a retainer which resists movement of the lid with respect to the base, the resistance being overcome, upon application of a sufficient separating force between the lid and base, without breaking the retainer or rendering the retainer inoperable for future use. Alternatively, the container 10 may include other types of retainers, such as a latch or magnet.

Referring to FIG. 1, the top side 35 of the lid 20 includes a first recessed area 65 and a second recessed area 70. In the illustrated embodiment, a logo plate 75 is attached to the first recessed area 65, while the second recessed area 70 provides a space for a user to attach or write a custom label. The logo plate 75 can be attached to the first recessed area 65 via ultrasonic welding, adhesive, fasteners, or the like. The edges of the second recessed area 70 include a minor draft angle or are sloped to assist in any secondary printing or coating processes. In some embodiments, the logo plate 75 may be electroplated to provide a particular metallic finish (e.g., chrome, gold, etc.).

In the illustrated embodiment, each of the walls 30, 35, 40 includes a faceted texture 80 having a plurality of angled surfaces. The faceted texture 80 may enhance the aesthetic appeal of the container 10, may make the container 10 easier to grip, and may make the container 10 more resistant to impacts. In other embodiments, one or more of the walls 30, 35, 40 may include a different texture or may not include texture.

In some embodiments, the faceted texture 80 has a maximum texture depth no greater than about 5 millimeters. As used herein, the term “texture depth” means a perpendicular distance between a plane intersecting an outermost point of the texture and a parallel plane intersecting an innermost point of the texture. In other embodiments, the faceted texture 80 has a maximum texture depth between about 1 millimeter and about 5 millimeters. In other embodiments, the faceted texture 80 has a maximum texture depth between about 2 millimeters and about 5 millimeters. In other embodiments, the faceted texture 80 has a maximum texture depth between about 3 millimeters and about 5 millimeters. In other embodiments, the faceted texture 80 has a maximum texture depth between about 4 millimeters and about 5 millimeters. In other embodiments, the faceted texture 80 has a maximum texture depth greater than 5 millimeters.

FIGS. 3 and 4 illustrate a container 110 according to another embodiment. The container 110 is similar to the container 10 described above with reference to FIGS. 1 and 2. Features and elements of the container 110 generally corresponding with features and elements of the container 10 are given like reference numbers plus 100. Each of the walls 130, 135, 140 of the illustrated container 110 is substantially smooth. In other embodiments, one or more of the walls 130, 135, 140 may include a texture, such as the faceted texture 80 described above with reference to FIGS. 1 and 2.

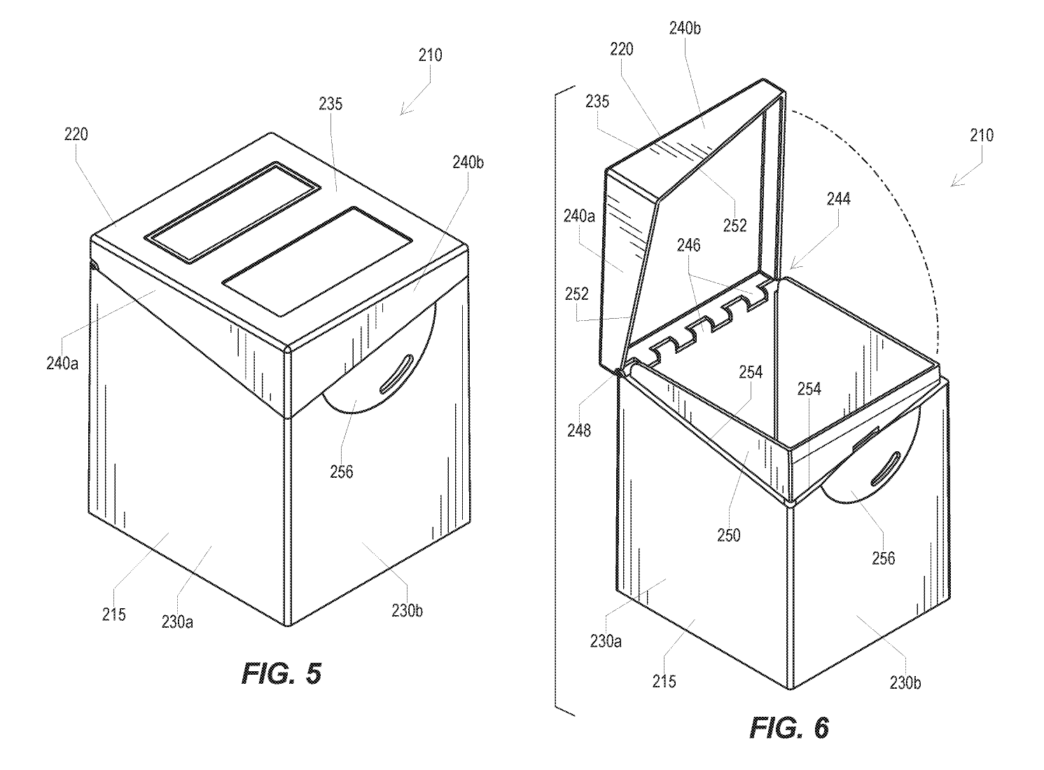

FIGS. 5 and 6 illustrate a container 210 according to another embodiment. The container 210 is similar to the container 10 described above with reference to FIGS. 1 and 2. Features and elements of the container 210 generally corresponding with features and elements of the container 10 are given like reference numbers plus 200.

The lid 220 and the base 215 of the container 210 are coupled together by a hinge 244. The hinge 244 includes a plurality of inter-engaging fingers 246 located on each of the lid 220 and the base 215, and one or more rods 248 that extends through coaxial apertures in fingers 246. As such, the lid 220 is pivotable about the rods 248 between the closed position (FIG. 5) and the open position (FIG. 6). In some embodiments, the container 210 may also include one or more springs configured to bias the lid 220 toward either the closed position or the open position.

In the illustrated embodiment of the container 210, two of the lid side walls 240a, 240b each include a bottom edge 252 that is angled relative to the top wall 235 (FIG. 6). As such, each bottom edge 252 forms an acute included angle with the top wall 235. The recessed portions 250 of the base side walls 230a, 230b corresponding with the lid side walls 240a, 240b also include angled edges 254 that abut the edges 252 when the lid 220 is in the closed position.

With continued reference to FIGS. 5 and 6, each of the walls 230, 235, 240 of the illustrated container 210 is substantially smooth; however, in the illustrated embodiment, the side wall 230b (which is the front side wall) includes a generally oval shaped recess 256 formed adjacent the angled edge 254. The recess 256 may receive a user's thumb, for example, to facilitate opening the lid 220 or gripping the base 215. This embodiment may also include a retainer to resist pivoting the lid 220 open and such retainer may be a detent, latch, magnet, or other suitable retainer as discussed above. In other embodiments, the wall 230b may also be substantially smooth and not include the oval shaped recess 256.

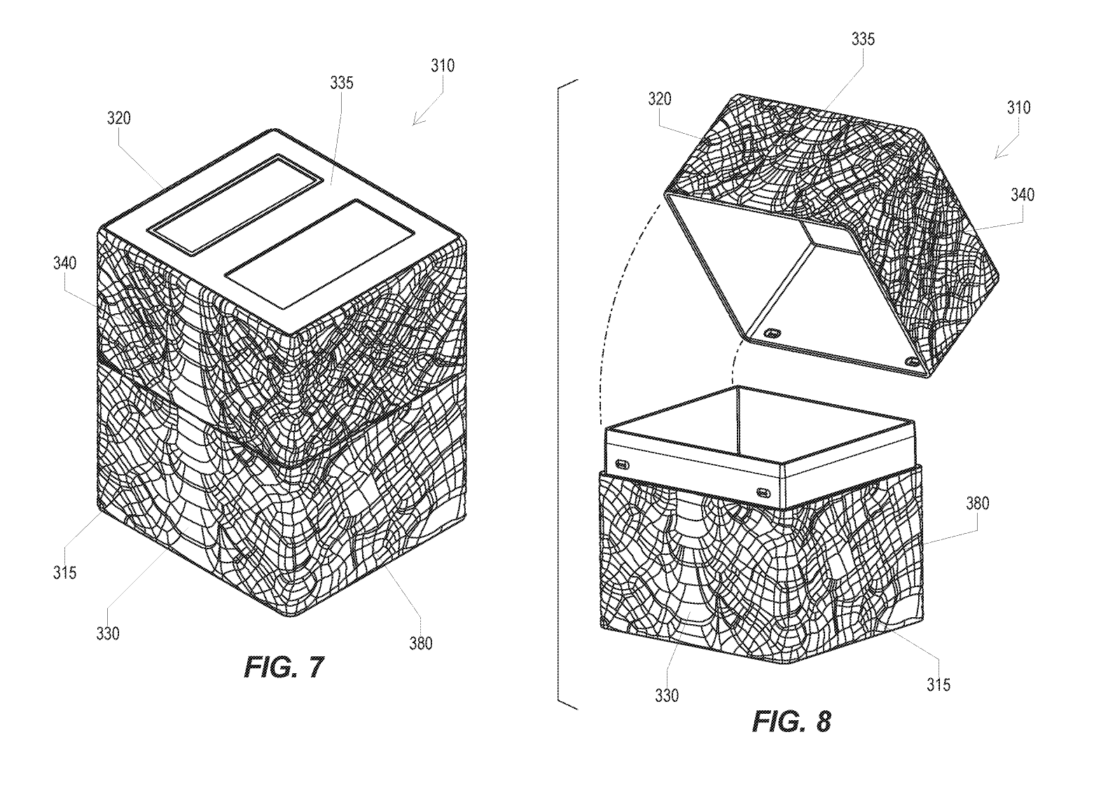

FIGS. 7 and 8 illustrate a container 310 according to another embodiment. The container 310 is similar to the container 10 described above with reference to FIGS. 1 and 2. Features and elements of the container 310 generally corresponding with features and elements of the container 10 are given like reference numbers plus 300.

Each of the walls 330, 335, 340 includes a scaled texture 380 having a plurality of grooves or indentations that form a scale-like appearance. The scaled texture 380 may enhance the aesthetic appeal of the container 310, may make the container 310 easier to grip, and may make the container 310 more resistant to impacts. In other embodiments, one or more of the walls 330, 335, 340 may include a different texture or may not include texture.

In some embodiments, the scaled texture 380 has a maximum texture depth no greater than about 5 millimeters. In other embodiments, the scaled texture 380 has a maximum texture depth between about 1 millimeter and about 5 millimeters. In other embodiments, the scaled texture 380 has a maximum texture depth between about 2 millimeters and about 5 millimeters. In other embodiments, the scaled texture 380 has a maximum texture depth between about 3 millimeters and about 5 millimeters. In other embodiments, the scaled texture 380 has a maximum texture depth between about 4 millimeters and about 5 millimeters. In other embodiments, the scaled texture 380 has a maximum texture depth greater than 5 millimeters.

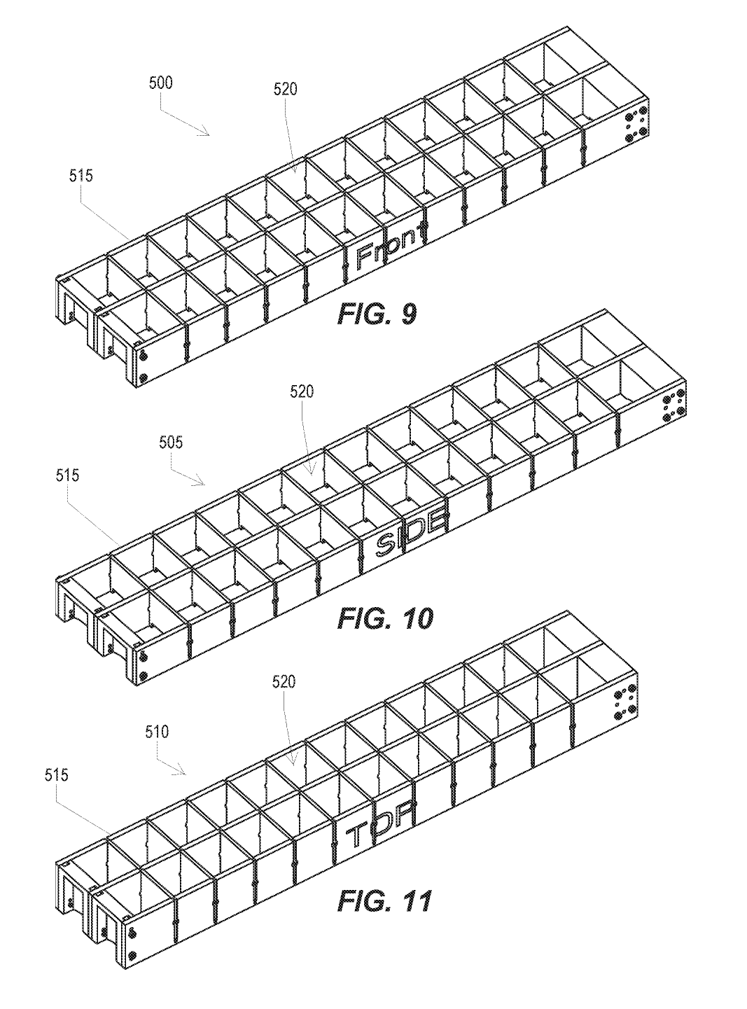

FIGS. 9-11 illustrate jigs 500, 505, 510 that may be used to facilitate printing a generally continuous image on one or more multi-sided containers, such as the containers 10, 110, 210, and 310. Each of the jigs 500, 505, 510 includes a frame 515 that defines a plurality of compartments 520. The frames 515 may be made of metal, plastic, or any other suitable material. Each of the compartments 520 has an open top side and an open bottom side. Each compartment 520 is sized and shaped to receive a single container. In the illustrated embodiment, each jig 500, 505, 510 includes two rows of twelve compartments 520 such that up to twenty-four containers may be positioned within a particular jig 500, 505, 510. In other embodiments, each jig 500, 505, 510 may include other numbers of compartments 520.

In the illustrated embodiment, each of the compartments 520 of the first jig 500 is sized and shaped such that either the front side or the back side of a container is exposed through the open top side of the compartment 520 when the container is positioned in the compartment 520 (FIG. 9). Each of the compartments 520 of the second jig 505 is sized and shaped such that either the left side or the right side of a container is exposed through the open top side of the compartment 520 when the container is positioned in the compartment 520 (FIG. 10). Finally, each of the compartments 520 of the third jig 510 is sized and shaped such that either the top side or the bottom side of a container is exposed through the open top side of open top side of the compartment 520 when the container is positioned in the compartment 520 (FIG. 11). In other embodiments, one or more of the jigs 500, 505, 510 may have a mixture of compartment configurations such that each jig 500, 505, 510 may receive containers in a variety of different positions.

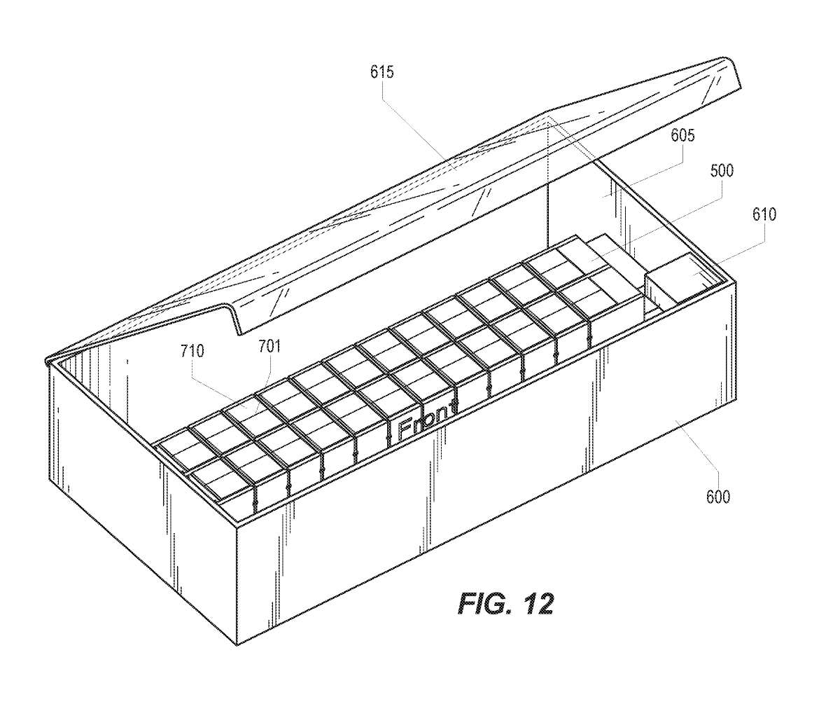

FIG. 12 illustrates the first jig 500 positioned in a printer 600. In the illustrated embodiment, the printer 600 is an ultra-violet (UV) inkjet printer and includes a bed 605, a printer head 610, and a lid 615. In other embodiments, other types of printers may be used. The printer head 610 includes outlets or nozzles (not shown) that selectively discharge ink on to a surface to be printed, and one or more UV light sources (not shown) that cure the ink after it is applied to the surface to be printed. The printer head 610 is movable along the bed to print on one or more containers 710 (which may be, for example, the containers 10, 110, 210, or 310). In the illustrated embodiment, the front side 701 of each container 710 faces up for exposure to the printer head 610. The containers 710 may also be rotated 180 degrees, either independently or together with the first jig 500, such that the back side 702 of each container 710 faces up for exposure to the printer head 610.

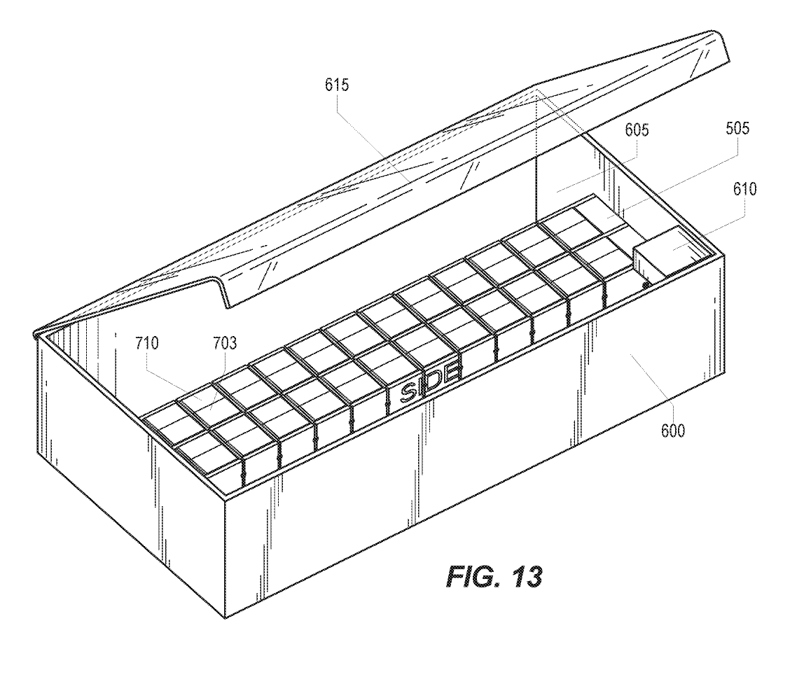

FIG. 13 illustrates the second jig 505 positioned in the printer 600. In the illustrated embodiment, the left side 703 of each container 710 faces up for exposure to the printer head 610. The containers 710 may also be rotated 180 degrees, either independently or together with the second jig 505, such that the right side 703 of each container 710 faces up for exposure to the printer head 610.

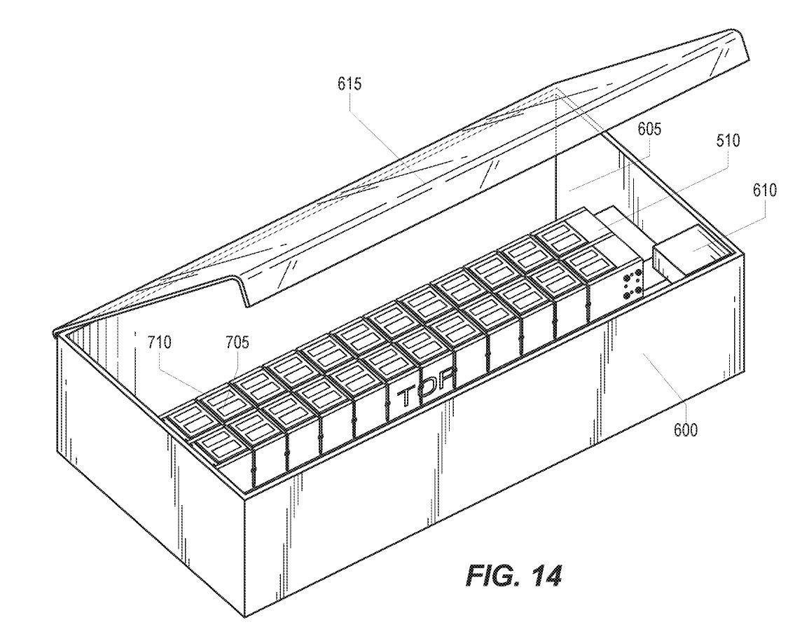

FIG. 14 illustrates the third jig 510 positioned in the printer 600. In the illustrated embodiment, the top side 705 of each container 710 faces up for exposure to the printer head 610. The containers 710 may also be rotated 180 degrees, either independently or together with the third jig 510, such that the bottom side 706 of each container 710 faces up for exposure to the printer head 610.

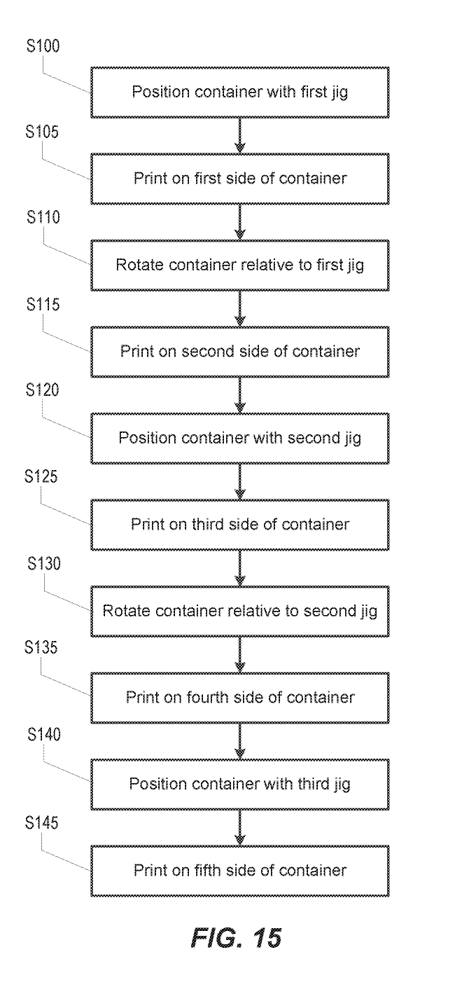

The jigs 505, 510, 515 and printer 600 can be used to print a generally continuous image or pattern that extends across multiple sides of the container 710. With reference to FIG. 15, the container 710 is positioned in the printer 600 using the first jig 500 at step S100, such that the front side 701 faces up. The printer head 610 then moves along the bed 605 and prints a portion of the image or pattern on the front side 701 of the container 710 at step S105. Next, at step S110, the container 710 is removed from the first jig 500, rotated 180 degrees, and repositioned in the first jig 500 with the back side 702 facing up. Alternatively, the first jig 500 may be rotated 180 degrees together with the container 710. The printer head 610 then moves along the bed 605 and prints another portion of the image or pattern on the back side 702 of the container 710 at step S115.

The first jig 500 can then be removed from the printer 600 and replaced by the second jig 505. The container 710 is positioned in the printer 600 using the second jig 505 at step S120, such that the left side 703 faces up. The printer head 610 moves along the bed 605 and prints a portion of the image or pattern on the left side 703 of the container 710 at step S125. Next, at step S130, the container 710 is removed from the second jig 505, rotated 180 degrees, and repositioned in the second jig 505 with the right side 704 facing up. Alternatively, the second jig 505 may be rotated 180 degrees together with the container 710. The printer head 610 then moves along the bed 605 and prints another portion of the image or pattern on the right side 704 of the container 710 at step S135.

The second jig 505 can then be removed from the printer 600 and replaced by the third jig 510. The container 710 is positioned in the printer 600 using the third jig 510 at step S140, such that the top side 705 faces up. The printer head 610 moves along the bed 605 and prints a portion of the image or pattern on the top side 705 of the container 710 at step S145. The container 710 can then be removed from the printer 600.

It should be understood that in some embodiments, the steps S100-S145 may be ordered differently, and one or more steps may be omitted if the image or pattern does not extend across all of the sides 730, 735, 740, for example.

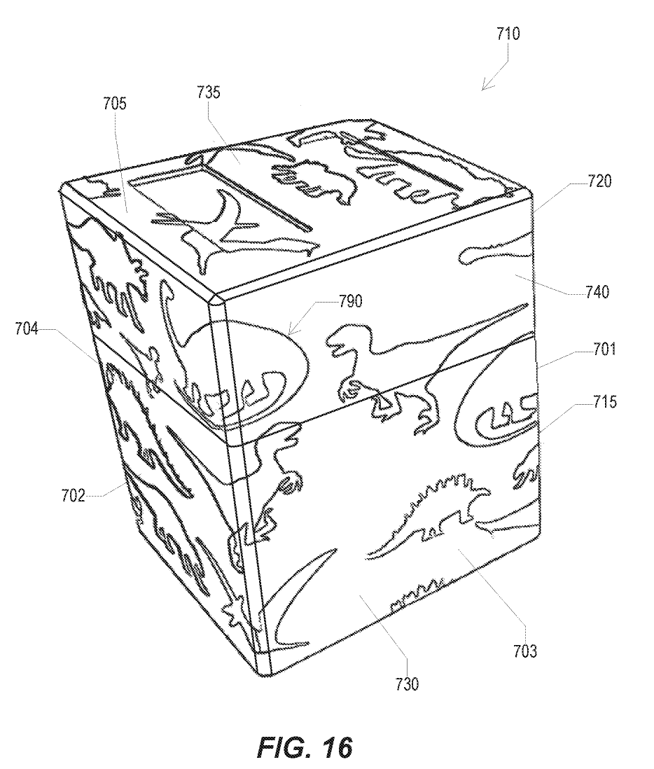

FIG. 16 illustrates the container 710 after being processed by the printer 600. The container 710 includes a generally continuous image or pattern 790 that is printed on the top wall 735 and each of the side walls 730, 740. Portions of the image 790 are substantially aligned at interfaces between adjacent side walls 730, 740 and at interfaces between the top wall 735 and each of the top side walls 730. Accordingly, the image 790 extends substantially uninterrupted across the four sides 701, 702, 703, 704 and top side 705 of the container 710. In addition, if one or more of the walls 730, 735, 740 includes a textured surface (e.g, the faceted texture 80 or the scaled texture 380), the image 790 can be printed directly on the textured surface. In some embodiments, after printing, a soft-touch coating, such as rubber oil or any other substantially transparent, rubberized coating, may be applied to one or more surfaces of the container 710.

Various features of the disclosure are set forth in the following claims.

What is claimed is:

1. A container for holding cards, the container comprising:
a base including a bottom wall and a first plurality of side walls extending from the bottom wall;
a lid movable relative to the base between an open position and a closed position, the lid including a top wall and a second plurality of side walls extending from the top wall, each of the second plurality of side walls being generally aligned with a corresponding one of the first plurality of side walls when the lid is in the closed position;
an internal storage volume at least partially defined by the bottom wall, the top wall, and the first and second pluralities of side walls; and
a generally continuous image printed on the first and second pluralities of side walls such that portions of the image are substantially aligned at interfaces between adjacent side walls.

2. The container of claim 1, wherein the lid is removably coupled to the base.

3. The container of claim 1, wherein the lid is pivotally coupled to the base.

4. The container of claim 3, further comprising a hinge pivotally coupling the lid to the base.

5. The container of claim 4, wherein one of the first plurality of side walls includes a generally oval-shaped recess to facilitate opening the lid.

6. The container of claim 1, wherein at least one of the base and the lid is made of ABS plastic.

7. The container of claim 1, wherein at least one of the base and the lid is made of metal.

8. The container of claim 1, wherein at least one wall of the first plurality of side walls and the second plurality of side walls includes a textured surface having a plurality of protruding or recessed regions, and wherein at least one portion of the image is printed on the textured surface.

9. The container of claim 8, wherein textured surface has a maximum texture depth between about 1 millimeter and about 5 millimeters.

10. The container of claim 9, wherein the textured surface is one of a plurality of textured surfaces defined on the top wall, each of the first plurality of side walls, and each of the second plurality of side walls, respectively.

11. The container of claim 10, wherein a portion of the image is printed on each of the plurality of textured surfaces.

12. The container of claim 1, wherein the image is printed on the top wall such that portions of the image are substantially aligned at interfaces between the top wall and the second plurality of side walls.

13. A method of printing a generally continuous image on a multi-sided container, the method comprising:
positioning the container in a printer using a jig;
printing a first portion of the image on a first side of the container with the printer;
rotating the container relative to the jig; and
printing a second portion of the image on a second side of the container with the printer.

14. A method of printing a generally continuous image on a multi-sided container, the method comprising:
positioning the container in a printer using a first jig;
printing a first portion of the image on a first side of the container with the printer;
rotating the container relative to the first jig;
printing a second portion of the image on a second side of the container with the printer;
positioning the container in the printer using a second jig;
printing a third portion of the image on a third side of the container with the printer;
rotating the container relative to the second jig;
printing a fourth portion of the image on a fourth side of the container with the printer;
positioning the container in the printer using a third jig; and
printing a fifth portion of the image on a fifth side of the container with the printer.

15. The method of claim 14, wherein the printer is a UV inkjet printer.

16. The method of claim 14, wherein at least one selected from a group consisting of the first side, the second side, the third side, the fourth side, and the fifth side includes protruding or recessed regions that form a texture.

17. The method of claim 16, wherein the texture has a maximum texture depth between about 1 millimeter and about 5 millimeters.

18. The method of claim 14, wherein each of the first side, the second side, the third side, the fourth side, and the fifth side includes protruding or recessed regions that form a texture.

19. The method of claim 18, wherein the texture has a maximum texture depth between about 1 millimeter and about 5 millimeters.

20. The method of claim 14, further comprising applying a substantially transparent, rubberized coating over the first side, the second side, the third side, the fourth side, the fifth side, and a sixth side.
